(19) United States
(12) Patent Application Publication
(10) Pub. No.: US 2026/0230718 A1
(43) Pub. Date: Aug. 6, 2026

(54) SENSOR DEVICE AND METHOD FOR OPERATING A SENSOR DEVICE

(71) Applicant: Sony Semiconductor Solutions Corporation, Kanagawa (JP)

(72) Inventors: Christian Peter BRÄNDLI, Aargau (CH); Andreas AUMILLER, Zurich (CH); Michael GASSNER, Stuttgart (DE); Kensei JO, Tokyo (JP)

(73) Assignee: Sony Semiconductor Solutions Corporation, Kanagawa (JP)

(21) Appl. No.: 19/150,210

(22) PCT Filed: Dec. 19, 2023
(86) PCT No.: PCT/EP2023/086541

§ 371 Date: Jul. 23, 2025

(30) Foreign Application Priority Data
Feb. 2, 2023 (EP) 23154731.6

(51) Int. Cl. H04N 23/84; H04N 25/47

(52) U.S. Cl. CPC H04N 23/84; H04N 25/47

(57) ABSTRACT

A sensor device configured to capture a video of a scene comprises a plurality of pixels each configured to receive light and perform photoelectric conversion to generate a pixel signal, the plurality of pixels comprising a first subset of pixels and a second subset of pixels, where pixels of the first subset of pixels are capable to generate pixel signals faster and preferably with less spatial resolution than pixels of the second subset of pixels, and wherein color frames can be generated from the pixel signals of the second subset of pixels, a processing unit that is configured to receive and process the pixel signals in order to generate video data, and a control unit that is configured to receive pixel signals from the first subset of pixels and to control operation modes of the processing unit based on the received pixel signals from the first subset of pixels.

### FIELD OF THE INVENTION

The present technology relates to a sensor device and a method for operating a sensor device, in particular, to a sensor device and a method for operating a sensor device that allows capturing a video of a scene.

### BACKGROUND

The spatial resolution of modern image sensors that are able to capture videos of scenes is steadily increasing. Moreover, also an increase of the temporal resolution, i.e. of the frames captured per second is desired.

It is therefore desirable to improve the image capturing capabilities of sensor devices that are configured to capture videos of scenes.

### SUMMARY OF INVENTION

To this end, a sensor device that is configured to capture a video of a scene is provided which comprises a plurality of pixels each configured to receive light and perform photoelectric conversion to generate a pixel signal, the plurality of pixels comprising a first subset of pixels and a second subset of pixels, where pixels of the first subset of pixels are capable to generate pixel signals faster and preferably with less spatial resolution than pixels of the second subset of pixels, and wherein color frames can be generated from the pixel signals of the second subset of pixels. The sensor device further comprises a processing unit that is configured to receive and process the pixel signals in order to generate video data and a control unit that is configured to receive pixel signals from the first subset of pixels and to control operation modes of the processing unit based on the received pixel signals from the first subset of pixels.

Further, a method for operating a sensor device that is configured to capture a video of a scene is provided, the method comprising: receiving light and performing photoelectric conversion with each of a plurality of pixels to generate a pixel signal with each of the pixels, the plurality of pixels comprising a first subset of pixels and a second subset of pixels, where pixels of the first subset of pixels are capable to generate pixel signals faster and with less spatial resolution than pixels of the second subset of pixels, and wherein color frames can be generated from the pixel signals of the second subset of pixels; receiving and processing the pixel signals by a processing unit in order to generate video data; and receiving pixel signals from the first subset of pixels in a control unit and controlling, by the control unit, operation modes of the processing unit based on the received pixel signals from the first subset of pixels.

Thus, the capabilities of two different subsets of pixels are used to improve the image capturing capabilities of the sensor device. The first subset of pixels is able to generate information on the scene with a very high time resolution. The second subset of pixels has a high spatial resolution and produces pixel signals that are used to generate color frames of the final video with the desired high spatial resolution. However, since driving these color pixels with very high frame rates is highly energy expensive and comes with problems as a need for dissipating heat from the color pixels, temporally highly resolved information is provided by the pixel signals of the first pixel subset. This information of the pixel signals of the first subset is used on the one hand to support generation of the video and on the other hand to control the mode of video generation. In this manner, the pixel data processing can be optimized based on the high-speed information from the first subset of pixels such that a high frame rate of the generated video can be achieved together with a reduced energy.

In order to allow such a high frame rates the pixels of the first subset may have a smaller spatial resolution than the pixels of the second subset. Additionally or alternatively, the data amount, e.g. the number of bits, produced by a pixel of the first subset is smaller than the data amount produced by a pixel of the second subset. Then, pixel signals from the first subset of pixels can be processed faster than pixel signals from the second subset.

In principle the pixels of the first subset of pixels may be any pixels that can generate data faster than the color pixels of the second subset of pixels. For example, sensor types which output the difference between intensity values of adjacent pixels or the difference between intensity values of pixels in the previous frame and encode it with a lower number of bits can be used as pixels of the first subset. Also, infrared pixels might be used. Further, it might also be possible to read out only a selected number of color pixels, or to read out pixels by using a lower number of bits than usual while increasing the frame rate.

However, in the following reference will mainly made to pixels of EVS (event-based vision sensor), DVS (dynamic vision sensor) or event cameras as the pixels of the first subset of pixels. Such event detecting pixels respond to brightness changes in each pixel by determining whether a change of received intensity is above a predetermined threshold. They can provide pixel signals at high speed, have a high dynamic range, and use less data compared with conventional color pixels.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic diagram of a frame data generation method based on event data.

FIG. 9 is a schematic block diagram of another quantization section.

FIG. 10 is a schematic diagram of another event detecting section.

FIG. 11 is a schematic block diagram of another pixel array section.

FIG. 12 is a schematic circuit diagram of another pixel block.

FIG. 13 is a schematic block diagram of a scan-type sensor device.

FIG. 14 is a schematic block diagram of a sensor device.

FIGS. 15A to 15E are schematic block diagrams showing distributions of pixels with different functions.

FIG. 16 illustrates schematically functions of a sensor device.

FIG. 17 illustrates schematically functions of a sensor device.

FIG. 18 shows schematic examples for event counting.

FIG. 19 illustrates schematically an encoding unit of a sensor device.

FIG. 20 illustrates schematically an image-based prediction unit of an encoding unit.

FIG. 21 refers schematically to frame data interpolation.

FIG. 22 illustrates schematically functions of a hybrid-based prediction unit of an encoding unit.

FIG. 23 illustrates schematically other functions of a hybrid-based prediction unit of an encoding unit.

FIG. 24 illustrates schematically other functions of a hybrid-based prediction unit of an encoding unit.

FIG. 25 illustrates schematically a process flow of a method for operating a sensor device

FIG. 26 is a schematic block diagram of a vehicle control system.

FIG. 27 is a diagram of assistance in explaining an example of installation positions of an outside-vehicle information detecting section and an imaging section.

FIGS. 28A and 28B show schematic examples of further applications of a sensor device.

### DETAILED DESCRIPTION

The present disclosure is directed to mitigating problems related to capturing video data having high spatial and temporal resolution. In particular, the problem is addressed how to reduce energy consumption of and heat generation in a pixel array of a sensor device used to capture video data with high temporal and spatial resolution. This is in principle achieved by using pixels with high spatial resolution and pixels with a high temporal resolution. The temporally highly resolved information obtained in this manner is used to ensure that from the captured frames of high spatial resolution video data are generated that share the high temporal resolution.

In this process it is in principle possible to combine any kinds of pixels that satisfy the requirement of different spatial resolution and different temporal resolution. However, in order to ease the description and also in order to cover an important application example the following description focuses on the use of pixels of an active pixel sensor, APS, to generate image frames with high spatial resolution, together with pixels of dynamic/event-based vision sensors, DVS/EVS, to generate event data showing intensity changes with a high temporal frequency in the range of several kHz, like e.g. 1 kHz, 5 kHz, 10 kHz, 15 kHz or even more (1 kHz corresponding to 1,000 frames per second). Here, the description will be particularly focused without prejudice on hybrid sensors that combine an active pixel sensor with a DVS/EVS. However, it has to be emphasized that the present disclosure is not restricted to a hybrid sensor or usage of a combination of APS and DVS/EVS. The underlying principles described in the following can be applied to any combination of relatively slow and spatially highly resolved pixels with relatively fast pixels, which produce less data that the spatially highly resolved pixels, e.g. by being spatially low resolved pixels.

To start, a possible implementation of a hybrid APS+DVS/EVS will be described. This is of course purely exemplary. It is to be understood that the hybrid sensor could also be implemented differently.

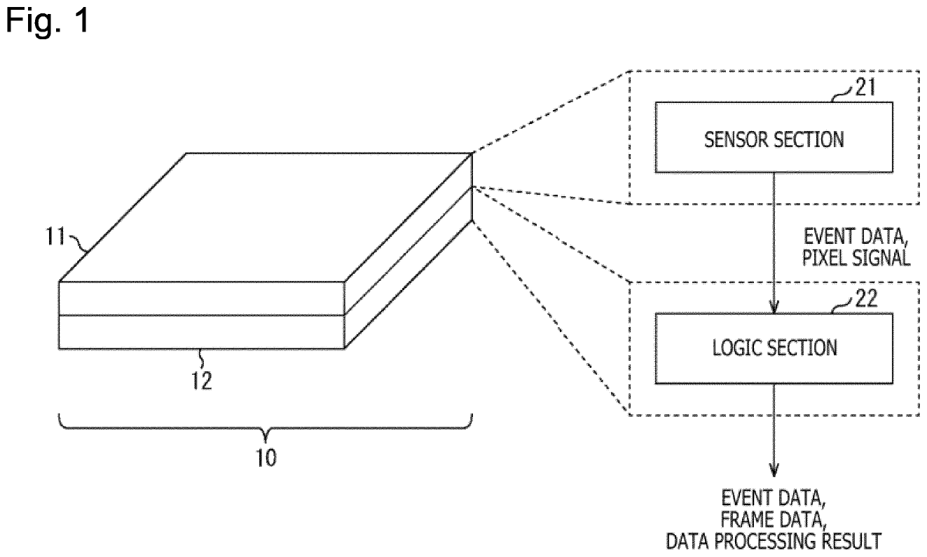

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals and to generate event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data.

Note that, the sensor section 21 can generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data.

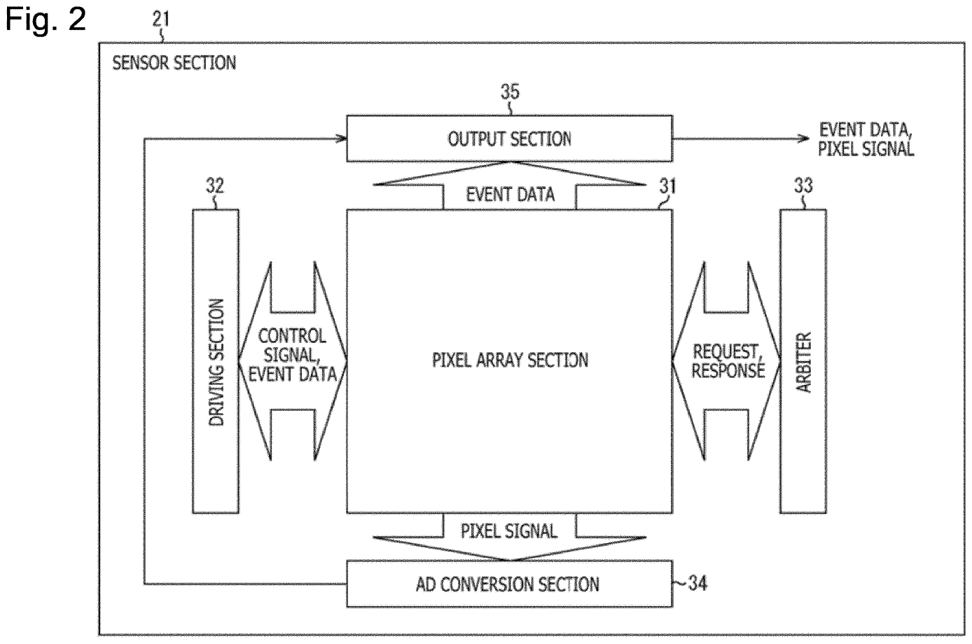

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

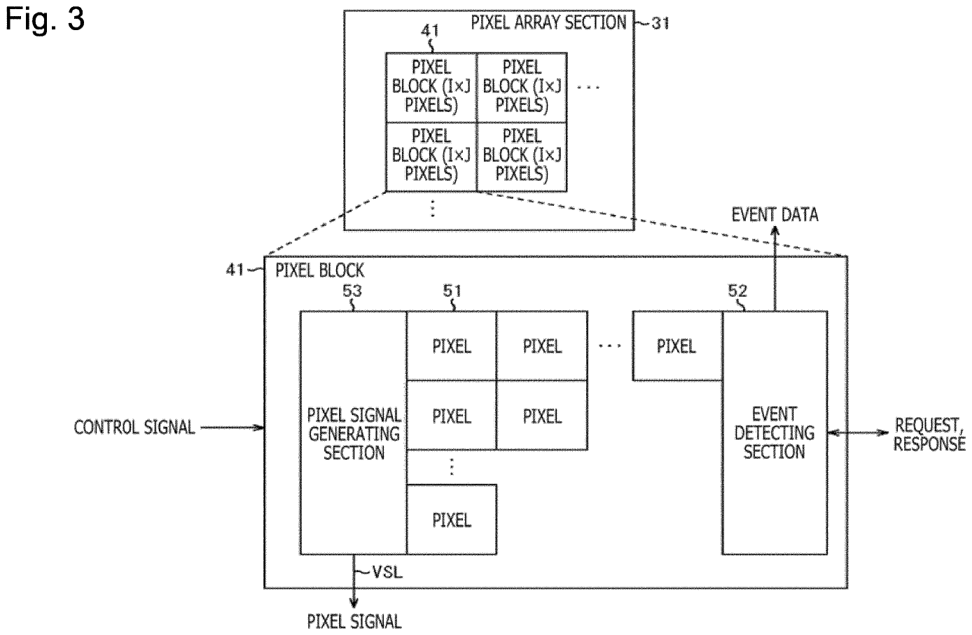

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34, as a pixel signal.

The driving section 32 supplies control signals to the pixel array section 31 to drive the pixel array section 31. For example, the driving section 32 drives the pixel 51 regarding which part of the pixel array section 31 has output event data, so that the pixel 51 in question supplies (outputs) a pixel signal to the AD conversion section 34. Alternatively, the driving section 32 drives the pixels 51 by applying a rolling shutter that starts readout of the pixel signals of adjacent pixel rows at times separated by a predetermined time period.

The arbiter 33 arbitrates the requests for requesting the output of event data from the pixel array section 31 and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost. Further, events may be read out at predetermined time points such as to generate the event data in a frame-like fashion.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 may generate, in the case where the event detecting section 52 has detected an event, a voltage corresponding to a photocurrent from the pixel 51 as a pixel signal, and supplies the voltage to the AD conversion section 34 through the VSL, under the control of the driving section 32. The pixel signal generating section 53 may generate pixel signals also based on various other triggers, e.g. based on a temporally shifted selection of readout rows, i.e. by applying a rolling shutter.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

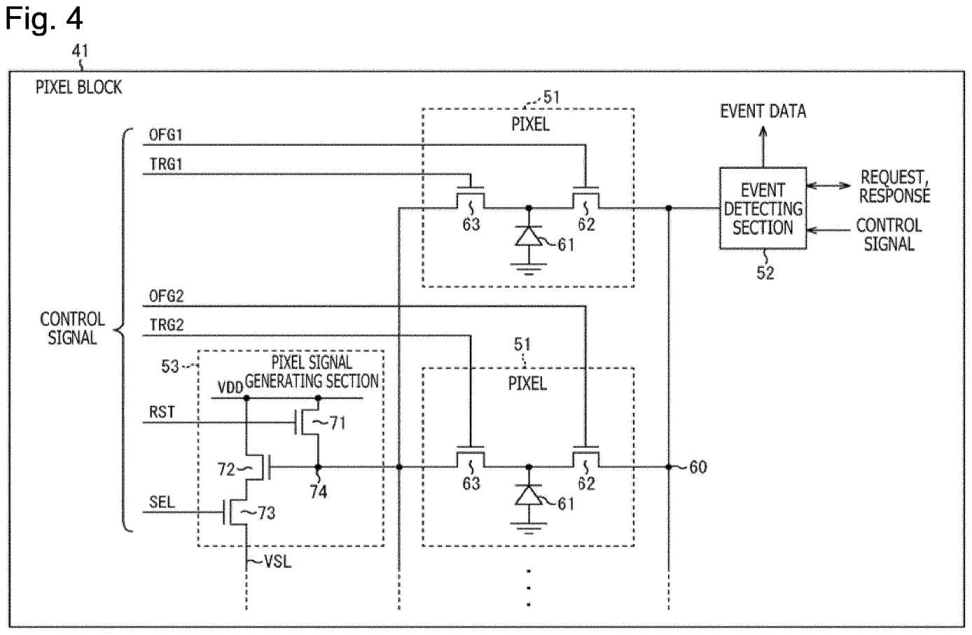

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63 and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

According to a possible operation mode, when the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

Alternatively, the transfer transistors 62, 63 may be used to switch the function of the pixel from event detection to pixel signal generation in a temporally predefined manner in order to provide a pixel 51 with time multiplexed function.

As described above, in the sensor section 21 (FIG. 2), only pixel signals of the pixels 51 in the pixel block 41 in which an event has been detected may be sequentially output to the VSL. The pixel signals output to the VSL are supplied to the AD conversion section 34 to be subjected to AD conversion. Alternatively, pixel signal readout is independent of event detection and pixel signal selection via the selection transistor 73 follows the concepts of a rolling or global shutter.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, e.g. since pixel signals are generated by a separate pixel array or a separate sensor device, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary, with a time stamp.

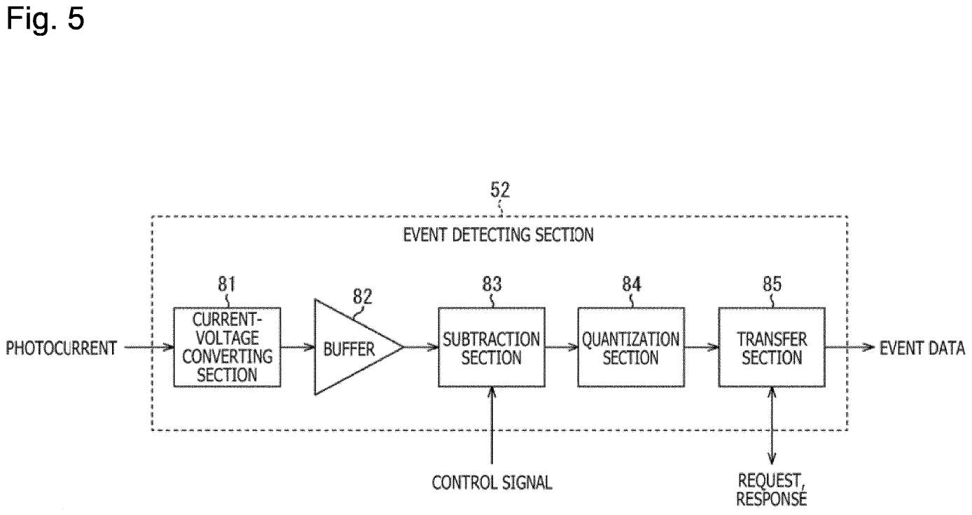

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

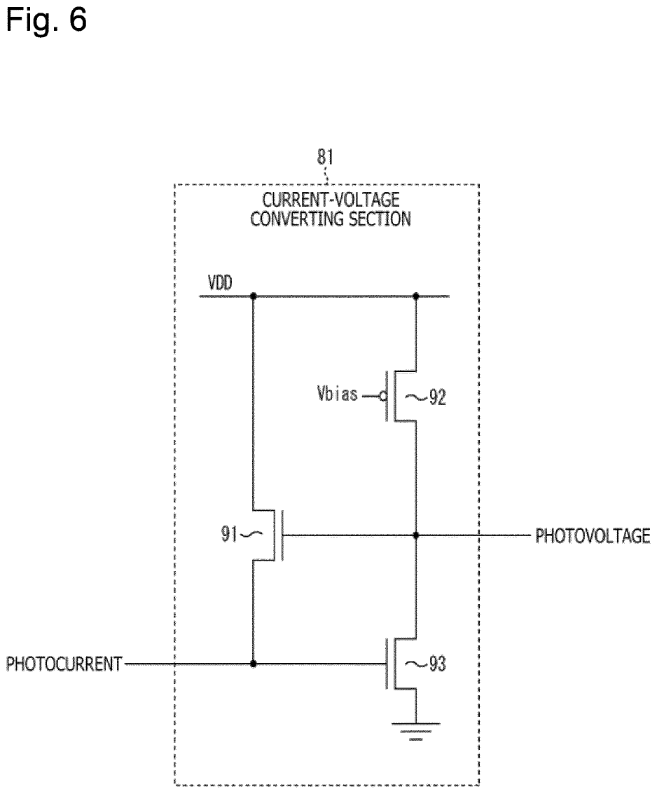

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

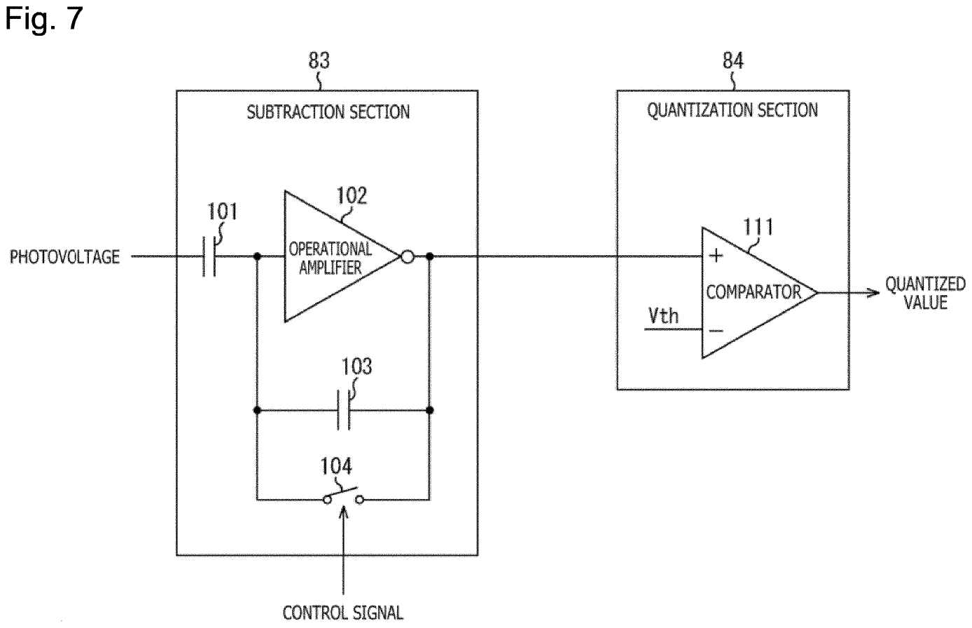

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter-Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = C {G}_{log} C 1 / C 2 ( \sum {i}_{p h o t o} \_n ) \qquad ( 6 )$$

Here, iₚₕₒₜₒ_n denotes a photocurrent of the n-th pixel 51 of the I×J pixels 51 in the pixel block 41. In Expression (6), 2 denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the following, the pixel 51 is assumed to receive visible light as incident light.

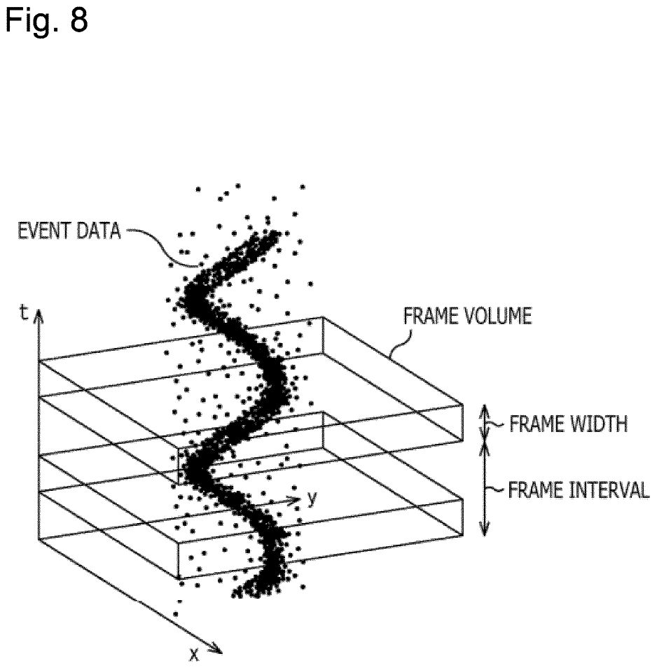

FIG. 8 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 8, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 8, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity. Alternatively, polarity values +1 and −1 may be assigned for each pixel in which an event of the according polarity has been detected and 0 may be assigned to a pixel in which no event was detected.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other. Event time stamp according to the end of the frame width can be set to all values within the event frame.

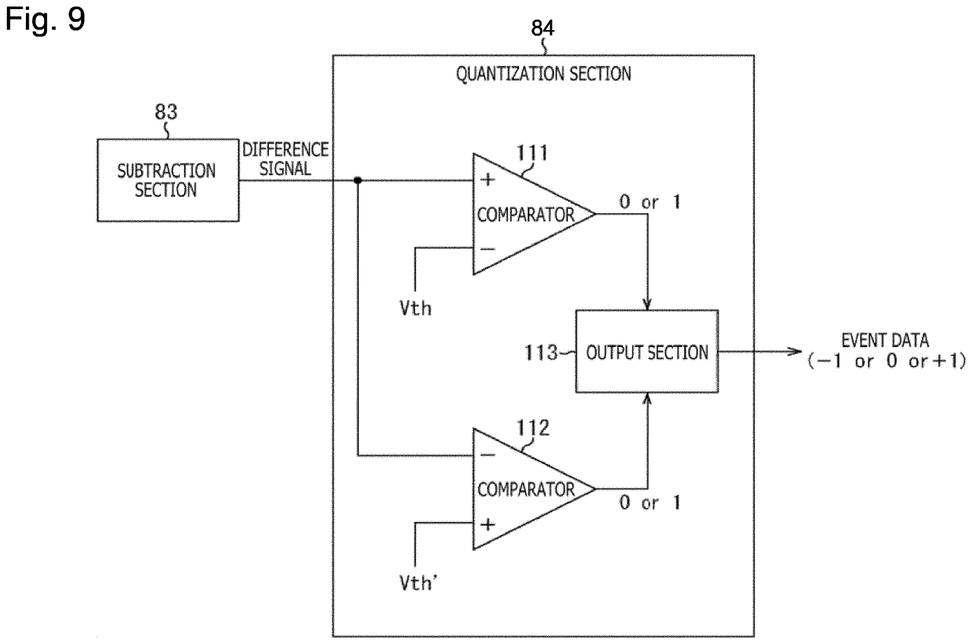

FIG. 9 is a block diagram illustrating another configuration example of the quantization section 84 of FIG. 5.

Note that, in FIG. 9, parts corresponding to those in the case of FIG. 7 are denoted by the same reference signs, and the description thereof is omitted as appropriate below.

In FIG. 9, the quantization section 84 includes comparators 111 and 112 and an output section 113.

Thus, the quantization section 84 of FIG. 9 is similar to the case of FIG. 7 in including the comparator 111. However, the quantization section 84 of FIG. 9 is different from the case of FIG. 7 in newly including the comparator 112 and the output section 113.

The event detecting section 52 (FIG. 5) including the quantization section 84 of FIG. 9 detects, in addition to events, the polarities of changes in light amount that are events.

In the quantization section 84 of FIG. 9, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 9, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 9.

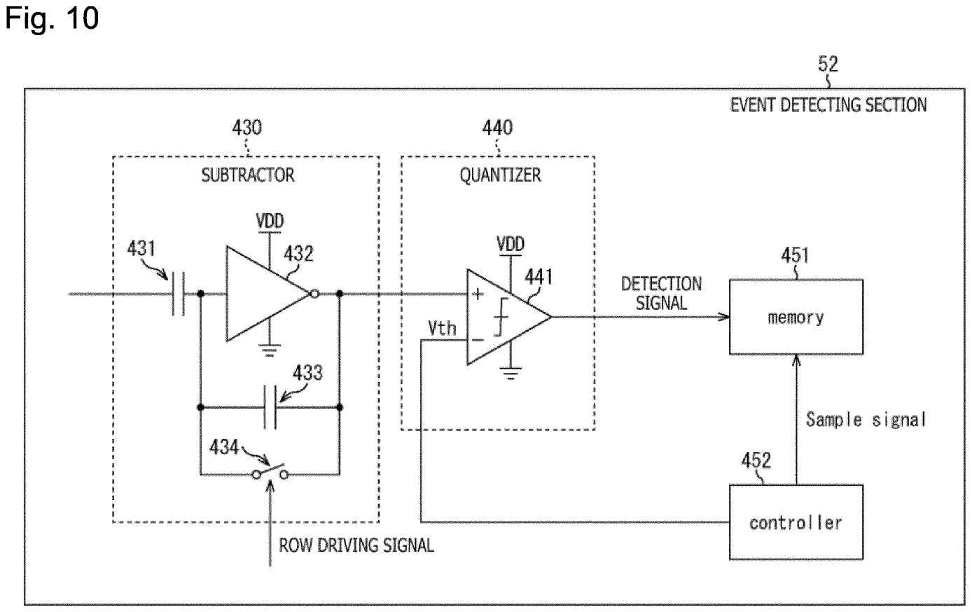

FIG. 10 is a diagram illustrating another configuration example of the event detecting section 52.

In FIG. 10, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 10, the event detecting section 52 further includes blocks corresponding to the current-voltage converting section 81 and the buffer 82, but the illustrations of the blocks are omitted in FIG. 10.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

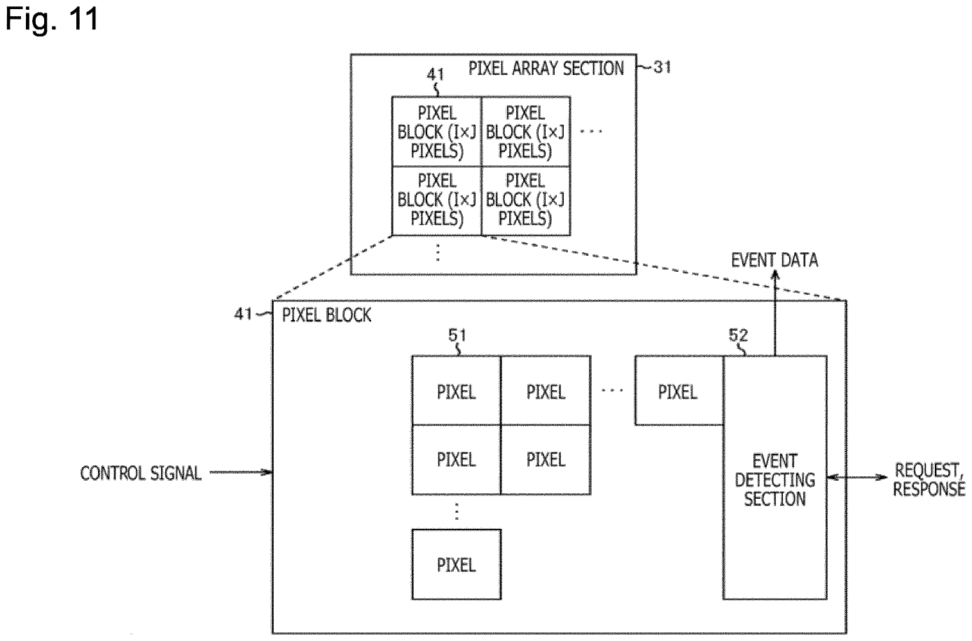

FIG. 11 is a block diagram illustrating another configuration example of the pixel array section 31 of FIG. 2, in which the pixels only serve event detection. Thus, FIG. 11 does not show a hybrid sensor, but an EVS/DVS.

Note that, in FIG. 11, parts corresponding to those in the case of FIG. 3 are denoted by the same reference signs, and the description thereof is omitted as appropriate below.

In FIG. 11, the pixel array section 31 includes the plurality of pixel blocks 41. The pixel block 41 includes the I×J pixels 51 that are one or more pixels and the event detecting section 52.

Thus, the pixel array section 31 of FIG. 11 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 11 is different from the case of FIG. 3 in that the pixel block 41 does not include the pixel signal generating section 53.

As described above, in the pixel array section 31 of FIG. 11, the pixel block 41 does not include the pixel signal generating section 53, so that the sensor section 21 (FIG. 2) can be formed without the AD conversion section 34.

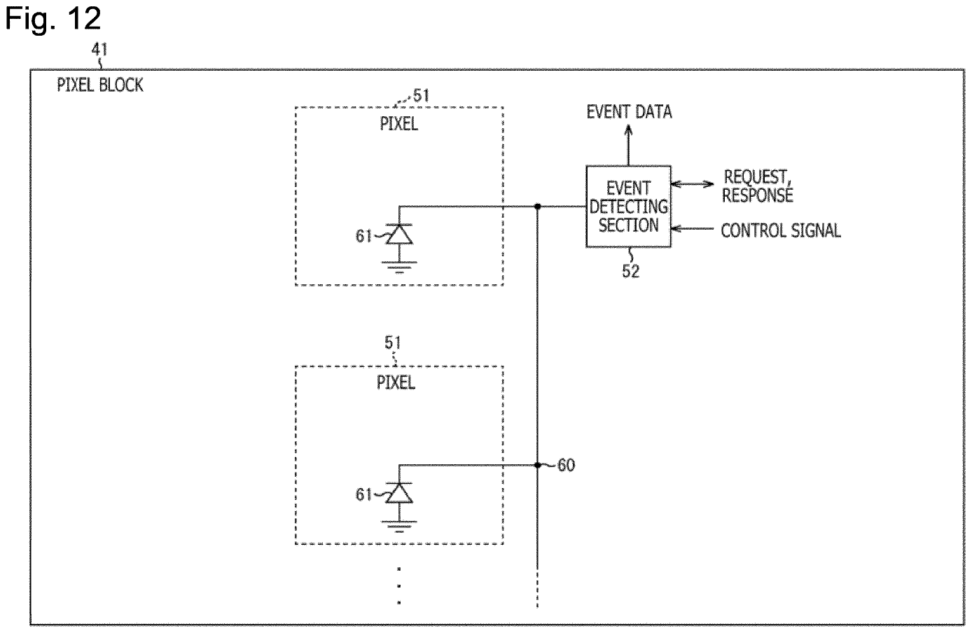

FIG. 12 is a circuit diagram illustrating a configuration example of the pixel block 41 of FIG. 11.

As described with reference to FIG. 11, the pixel block 41 includes the pixels 51 and the event detecting section 52 but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 12, the event detecting section 52 can output a voltage corresponding to a photocurrent from the pixel 51, as a pixel signal.

Above, the sensor device 10 was described to be an asynchronous imaging device configured to read out events by the asynchronous readout system. However, the event readout system is not limited to the asynchronous readout system and may be the synchronous readout system. An imaging device to which the synchronous readout system is applied is a scan type imaging device that is the same as a general imaging device configured to perform imaging at a predetermined frame rate.

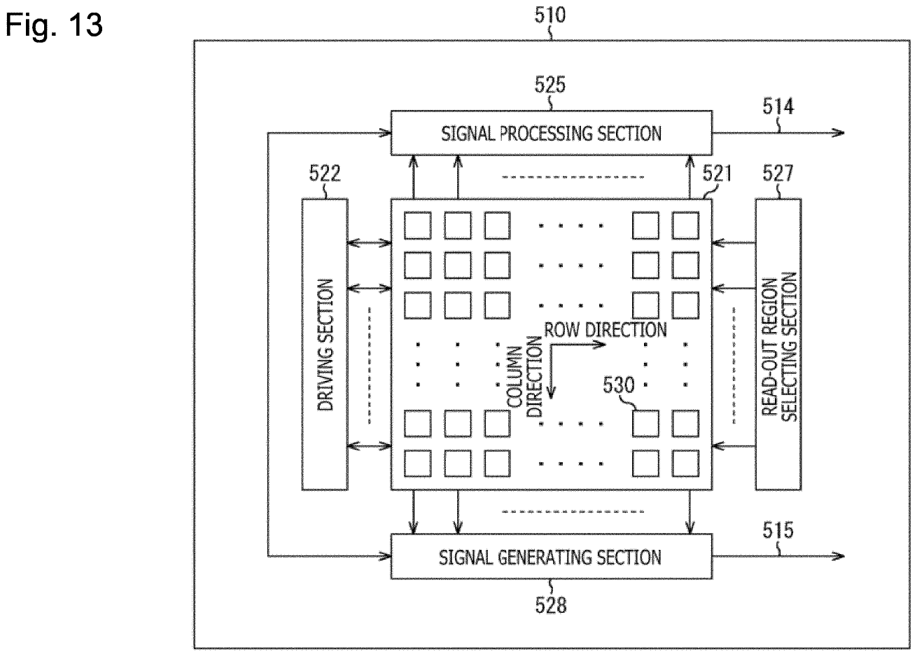

FIG. 13 is a block diagram illustrating a configuration example of a scan type imaging device, i.e. of an active pixel sensor, APS, which may be used in the sensor device 10 together with the EVS illustrated in FIG. 12.

As illustrated in FIG. 13, an imaging device 510 includes a pixel array section 521, a driving section 522, a signal processing section 525, a read-out region selecting section 527, and an optional signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 10, for example. The plurality of pixels 530 outputs output signals corresponding to the amounts of change in light intensity. The plurality of pixels 530 may be two-dimensionally disposed in a matrix as illustrated in FIG. 13.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance, e.g. based on a rolling shutter. Further, the read-out region selecting section 527 may determine a selection region on the basis of requests from the pixels 530 in the pixel array section 521.

The optional signal generating section 528 may generate, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

Above different sensor designs have been discussed which combine the capability to generate event data and full intensity pixel signals e.g. by sharing pixel signals between different circuitries, by dividing a pixel to have both functionalities or by combining event data and pixel signals of different sensor chips or sensors. It is understood that the above is merely exemplary and that any other implementation may be chosen that allows a concurrent generation of event data and intensity signals.

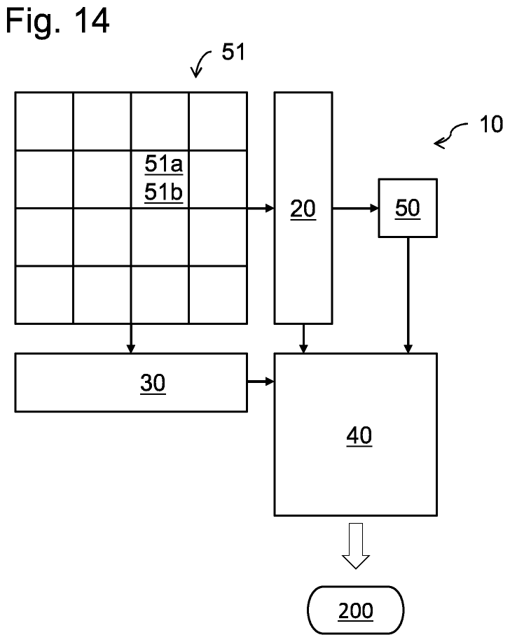

In all these examples a sensor device 10 as shown in FIG. 14 is provided that comprises a plurality of pixels 51 that are each configured to receive light and perform photoelectric conversion to generate a pixel signal, the plurality of pixels 51 comprising a first subset of pixels and a second subset of pixels, where pixels 51a of the first subset of pixels are capable to generate pixel signals faster than pixels 51b of the second subset of pixels, by producing for example a smaller amount of data, e.g. less bits per pixel, or by having lower spatial resolution than the second subset of pixels, and wherein color frames can be generated from the pixel signals of the second subset of pixels.

As described above, in order to ease the description it is assumed that the pixels 51a of the first subset of pixels are event detecting pixels 51a and that the pixels 51b of the second subset of pixels are intensity detecting pixels 51b, i.e. pixels of an APS. In this case, the sensor device 10 comprises event detection circuitry 20 that is configured to generate as pixel signals event data by detecting as events intensity changes above a predetermined threshold of the light received by each of the event detecting pixels 51a. The event detection circuitry 20 may for example have the form described above with respect to FIG. 5 to 7, 9 or 10.

Further, the sensor device comprises in this case intensity signal generating circuitry 30 that is configured to generate as pixel signals intensity signals indicating intensity values of the light received by each of the intensity detecting pixels 51b. The intensity signal generating circuitry 30 may for example have the form described above with respect to FIG. 5 or 13.

As illustrated in FIG. 14, each of the pixels 51 may function as event detection pixel 51a and as intensity detecting pixel 51b. The pixels 51 may have both functionalities at the same time by distributing the electrical signal generated by photoelectric conversion at the same time to the event detection circuitry 20 and the pixel signal generating circuitry 30.

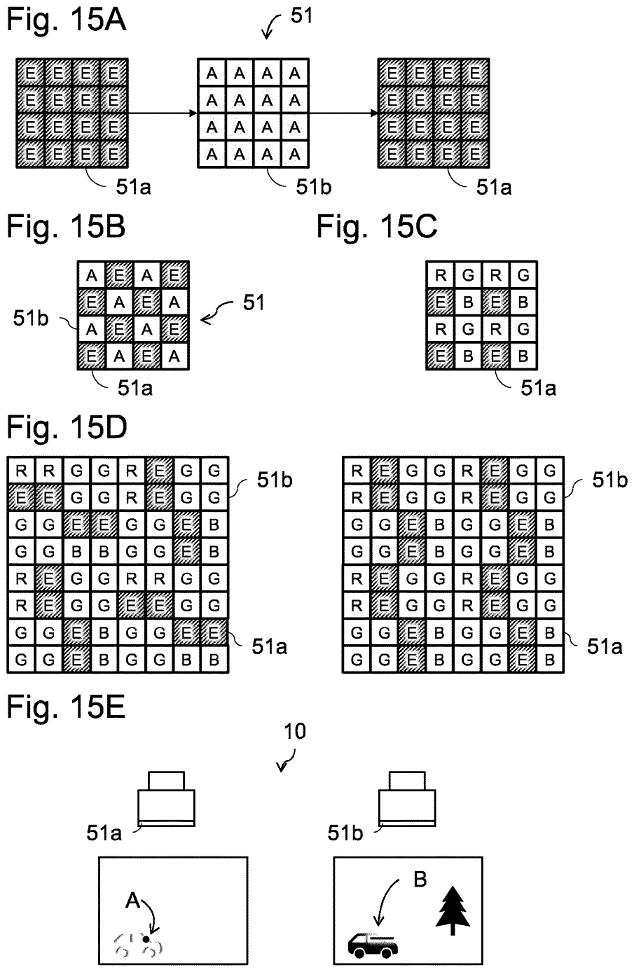

Alternatively, the pixels 51 may be switched between event detection and pixel signal generation as e.g. described above with respect to FIG. 4 and schematically illustrated in FIG. 15A. Here, it is assumed that all pixels 51 operate first as event detecting pixels 51a and switch then to an operation as intensity detecting or APS pixels 51b. Afterwards, the cycle starts again with event detection functionality.

Thus, the first subset of pixels 51 may be equal to the second subset of pixels 51. Alternatively, the first and second subsets of pixels 51 may at least in parts be different. This is exemplarily illustrated in FIGS. 15B to 15E.

Here, FIG. 15B shows a situation in which event detecting pixels 51a are arranged in an alternating manner with intensity detecting pixels 51b. Thus, it is possible to capture event and intensity information simultaneously by using different sets of EVS and APS pixels.

FIGS. 15C and 15D show examples of RGB-Event hybrid sensors in which color filters are provided on each of the intensity detecting pixels. This allows capturing both, color image frames and events. Here, different exposure times may be used for pixel signal and event data readout, e.g. a fixed frame rate can be set for readout of RGB frames, while events are readout asynchronously at the same time. As schematically indicated in FIG. 15D pixels having the same color filter or the same functionality can be read out together as single pixels. Pixels having the same color filter may also have different exposure times in order to increase the dynamic range of the color frames generated therefrom.

Of course, it is to be understood that the arrangement of color filters and event detecting pixels 51a within the pixel array may be different than shown in FIGS. 15B to 15D. Moreover, the sensor device 10 may include further event detecting pixels 51a and/or intensity detecting pixels 51b that have both functionalities and/or are not part of the pixel array.

The above examples relate to pixels 51 belonging to different pixel subsets, but being part of a single sensor chip. However, the event detecting pixels 51a and the intensity detecting pixels 51b may also be part of different sensor chips or even different cameras of the sensor device 10.

For example, FIG. 15E shows a stereo camera constituting the sensor device 10 in which one camera uses event detecting pixels 51a, i.e. is an EVS, while the other camera uses intensity detecting pixels 51b, i.e. is an APS. Here the EVS captures moving objects (like the car in the example of FIG. 15D) with a high time resolution and low latency, while the APS captures all objects on the scene (car and tree) with a smaller temporal resolution.

In all of the above examples the generation of event data and the generation of pixel signals are synchronized such as to allow an assignment of time according to the same time coordinate to event data generation and pixel signal generation. Differently stated, both the event detection circuitry 20 and the pixel signal generation circuitry 30 operate based on the same clock cycle, not only in the case of a shared pixel array, but also for a system of geometrically separated pixel arrays as the one of FIG. 15E.

As illustrated in FIG. 14, the sensor device 10 further comprises a processing unit 40 that is configured to receive and process the pixel signals in order to generate video data 200. The processing unit 40 is capable to carry out all steps necessary to convert the raw pixel data into video data consisting for example of a series of encoded frame data like an MPEG or HEVC video stream. As will described later, the processing unit 40 is capable to process event data as well as intensity data. In particular, the processing unit 40 is capable to generate an encoded video stream by image signal processing and encoding raw intensity signals. Here, the event data may be used by the processing unit 40 to supplement and/or refine the generation of video data.

The sensor device 10 comprises further a control unit 50 that is configured to receive pixel signals from the first subset of pixels, i.e. event data according to the present example, and to control operation modes of the processing unit 40 based on these received pixel signals from the first subset of pixels. It is understood that the control unit 50 may additionally also operate based on further information, like e.g. the pixel signals from the second subset of pixels.

The control unit 50 as well as the processing unit 40 may be constituted by any circuitry, processor or the like that is capable to carry out the functions described below. The control unit 50 may be implemented as hardware, as software or as a mixture of both. The processing unit 40 and the control unit 50 may be part of the logic section 22 but may also be formed in a separate die that may or may not be integrally connected to the sensor die 11 that comprises the plurality of pixels 51.

Due to the presence of the intensity detecting pixels 51b the sensor device 10 is capable to generate intensity signals with high spatial resolution. These intensity signals can be processed to color frames which are encoded in the processing unit 40 according to standard procedures well known to a skilled person. However, in order to generate video data 200 with a high temporal resolution, i.e. with a high frame rate, of e.g. 60 frames per second or more, it is necessary to drive the intensity detecting pixels 51b with the same high frame rate. This leads to an increase of energy consumption as well as to an increased generation of heat. Thus, driving the intensity detecting pixels 51b with high frame rates quickly depletes energy resources of mobile devices carrying the sensor device 10, such as mobile phones or head mounted displays. Further, the increased heat generation may damage the pixels 51 of the sensor device 10. Thus, it is not possible to generate video data with high frame rates and high spatial resolution over an extended period of time.

In view of this situation it has been noted that for videos of high frame rate changes between single frames are most often small due to the high frame rates. Accordingly, in encoding the captured color frames a large part of information is discarded as redundant. Generating full frame information for all frames at high costs for energy depletion and system integrity has been found to be unnecessary, since most of the information is not used in generating the video data 200.

Instead, in the sensor device 10 temporally highly resolved information on the captured scene that is spatially dispersed, i.e. of low spatial resolution, or has a reduced data amount is used on the one hand to support the video data generation process. On the other hand, this information can be used to control the optimal processing of all the generated pixel signals. Supplementing color frame information with event data can for example help to reduce the capturing frame rate of intensity signals, since the motion information contained in the event data can be used to increase the frame rate of the encoded frame data in the video data 200. Further, knowledge about changes in the captured scene which is contained in the event data can be used to control image capturing, image processing, and image encoding.

In this manner it is possible to reduce the energy consumption by reducing the necessity to capture intensity signals with a high frame rate, while it can on the other hand be ensured that the final video data 200 still has the desired high frame rate. Further, also energy consumption in generating video data 200 having a normal frame rate of 24 or 30 frames per second can be reduced by replacing the generation of image frames with information from the event data.

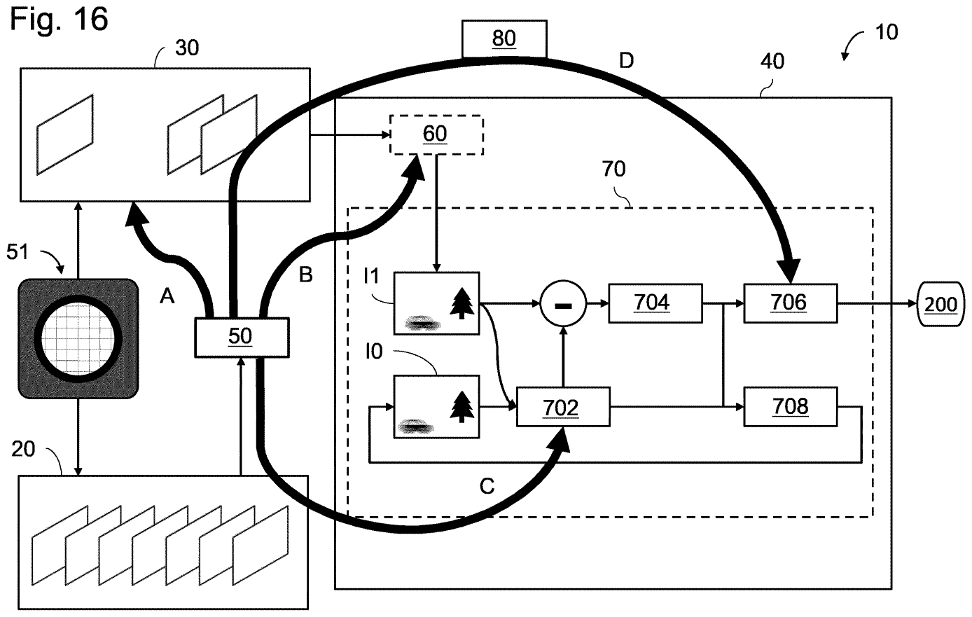

FIG. 16 provides a schematic overview that explains how the information of the event data can be used to influence the video data generation process in the manner described above.

As shown in FIG. 16 the pixels 51 generate event data via the event detection circuitry 20 and frames of raw intensity signals via the intensity signal generating circuitry 30. While the event detection circuitry 20 can generate event data in an asynchronous manner at rates in the range of several kHz, the intensity signal generating circuitry 30 operates at frame rates of 24 to 60 frames per second.

The event data are provided to the control unit 50 that is capable to influence the image capturing and the image processing in various instances, based on the event data. The different possibilities of control are indicated by thick arrows in FIG. 16. Here, it is to be understood that the sensor device 10 may be controlled according to all, some or just one of the following control modes.

According to a mode A the generation/readout of (frames of) intensity signals can be reduced based on the amount of motion in a scene as deducible from event data. Event data can then be used to perform temporal up-sampling of the vide data stream. Moreover, for small amounts of motion or almost static scenes interpolation between captured frames may be possible without event data. Although this leads to an increase of computation at the processing unit 40 the energy saving effects due to not fully reading out redundant frame information is larger. Moreover, an increase in heat generation is avoided.

While control mode A influences the pixel control of the sensor device 10, control modes B to D influence the processing unit 40. To allow a better understanding of these control modes FIG. 16 illustrates schematically different functions of the processing unit 40.

In particular, the processing unit 40 may comprise a pixel signal processing unit 60 that is configured to receive the pixel signals of the second subset of pixels, i.e. the intensity signals, and to process the received pixel signals in order to generate color frames therefrom. The pixel signal processing unit 60 is for example an image signal processor, ISP, that de-mosaics raw data of the intensity detecting pixels 51b, which are e.g. provided with color filters in a Bayer-pattern, to generate RGB or YUV information for each pixel. But the pixel signal processing unit 60 may also have other functions that preprocess the raw intensity signals such as to improve their encoding capabilities.

Further, the processing unit 40 may comprise an encoding unit 70 that is configured to generate the video data 200 by encoding the color frames output by the pixel signal processing unit 60. The encoding unit 70 may operate in principle as is well know to a skilled person, and as is schematically illustrated in FIG. 16. The pixel signal processing unit 60 inputs the current frame I1 to the decoding unit. Based on the current frame I1 and a previous frame I0 a prediction unit 702 generates a prediction for the current frame I1. This prediction is subtracted from the actual current frame to generate a residual, which is transformed and quantized in a quantization unit 704 and coded in a coder unit 706. It is this quantized and coded residual which constitutes the encoded frame data in the video data 200, if it is assumed that in decoding the residual can be combined with a previously decoded full frame to also generate a full frame. In the language of HEVC, the residual constitutes the encoded frame data for P- and B-frames, while the full color frame is only encoded for I-frames. The quantized residual is dequantized in dequantization unit 708 and combined with the predicted current frame to form the actual current frame I1, which is then stored to be used as previous frame in the next time step.

The above-described classical operation of the processing unit 40 can be influenced by the control unit 50 based on the event data in the following manners.

According to control mode B the event data can be used to control the pixel signal processing unit 60. For example, the pixel signal processing unit 60 can be disabled at static scenes, since in this situation the previous frame can be used for encoding.

According to control mode C the event data can be used to control and/or supplement the encoding modes of the encoder unit 70. The event data can be used to speed up, improve or control the image partitioning, i.e. the block size, used for encoding. Further, based on the detected events it may be possible to decide which frame becomes an I, P or B frame, or how to interpolate missing frames of intensity signals/color frames. Moreover, the event data may also be used to supplement, refine, or even replace motion estimation as performed in the prediction unit 702 in order to improve the speed and computational load of the codec.

Finally, in control mode D a neural network 80 may be used to directly transform raw intensity signals and event data to an encoded movie.

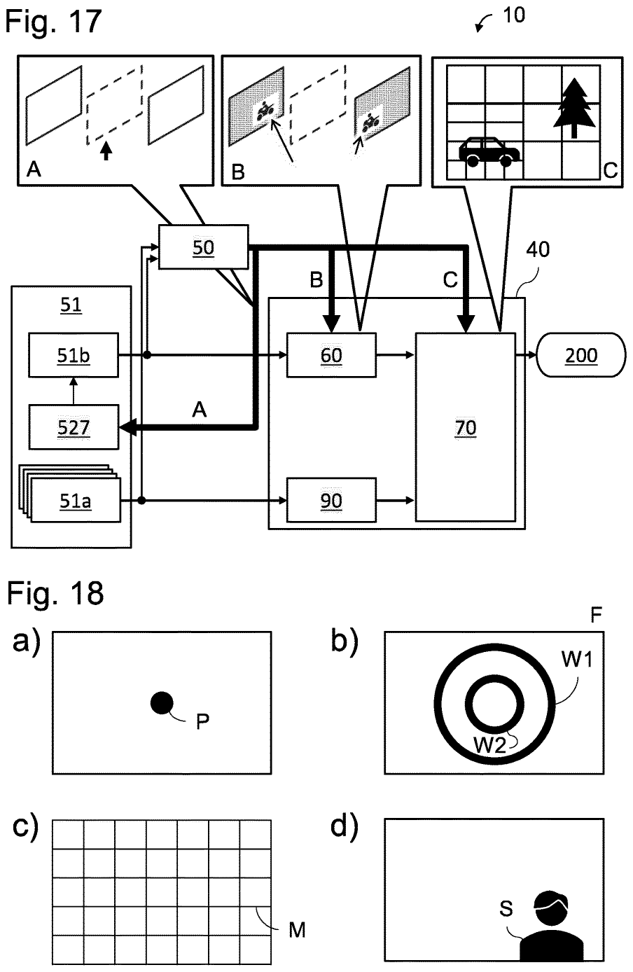

Whether or not to implement these control modes can be decided by the control unit 50 based on the events detected by the event detecting pixels 51a during predetermined time periods. Various examples of the controls that can be implemented by the control unit 50 will be described in the following with respect to FIG. 17, which again shows schematically the elements of the sensor device 10 described with respect to FIG. 16 above.

As indicated by arrow A in FIGS. 16 and 17 the control unit 50 is configured to control readout of the pixel signals from the second subset of pixels, i.e. the intensity detecting pixels 51b, based on the pixel signals from the first subset of pixels, i.e. the event data, which were provided to it.

In particular, the control unit 50 may be configured to determine an amount of motion in the captured scene from the event data. The control unit 50 may then lower a readout rate of pixel signals of the second subset of pixels, i.e. of frames of raw intensity signals, if the determined amount of motion is below a predetermined first motion threshold. In this manner, the generation/readout of intensity signals may be skipped for a given time interval (see e.g. FIG. 16, inset A), for which it is determined that the captured scene shows only little motion or is almost static, since in this case reading out full frames of intensity signals will only lead to redundant information and can be skipped without deteriorating the quality of the final video data 200. Just the same, the control unit 50 may also increase the frame rate, if the determined amount of motion exceeds a given threshold.

The missing frame can be interpolated during encoding based on the event data captured for the given frame period. An example of such a processing will be described later with respect to FIGS. 21 and 22.

Further, the control unit 50 may also set an operation mode of the processing unit 40 in which the processing unit 40 is configured to interpolate between readout pixel signals of the second subset of pixels in order to generate the video data with a predetermined frame rate, preferably with a frame rate of 60 or more frames per second. Thus, in this case the processing unit carries out an interpolation of the raw intensity signals, e.g. a linear interpolation, before generating color frames from the intensity signals in the pixel signal processing unit 60. The interpolation may for example by carried out by the pixel signal processing unit 60 or an additional (not shown) unit.

In such a manner energy consumption and heat generation at the sensor die 11 can be reduced while video data 200 with a high (or normal) frame rate can be generated.

Instead of controlling the generation/read out of intensity signals the control unit 50 is also capable to control the pixel signal processing unit (see arrow B in FIGS. 16 and 17).

In this case, the control unit 50 is configured to determine an amount of motion in parts of the captured scene from the event data. This means e.g. that the scene is segmented in areas of a given size and for each of these areas the number of events is detected, which indicates the amount of motion.

The control unit 50 is then configured to set an operation mode of the processing unit 40 in which the pixel signal processing unit 60 is configured to generate frames from the pixel signals of the second subset of pixels, i.e. from the intensity signals, in which intensity signals corresponding to parts of the scene with an amount of motion below a predetermined second motion threshold are processed differently than pixel signals corresponding to parts of the scene with an amount of motion equal to or above the second motion threshold.

This allows to focus the processing of intensity signals to positions of interest, i.e. to areas that show a sufficient degree of change, while areas of the captured scene with little or no motion are processed in a different, possibly power saving manner.

In particular, the control unit 50 may control the pixel signal processing unit 60 to process the intensity signals corresponding to parts of the scene with an amount of motion equal to or above the second motion threshold such as to generate color frame data therefrom, and to not process the intensity signals corresponding to parts of the scene with an amount of motion below the second motion threshold or to process these intensity signals by generating grayscale frame data therefrom. Alternatively, also the resolution of the color frame in regions with little or no motion could be reduced by the pixel signal processing unit 60.

Accordingly, the raw intensity data are only fully de-mosaiced in areas of interest, while in the remaining areas of the captured scene the raw data are maintained or are only processed to grayscale (see e.g. FIG. 17, inset B). This reduces power consumption since image processing in areas containing only redundant information is omitted. In particular, since the captured raw intensity frames differ from previous frames only in subregions of the entire captured scene, they would be encoded as P- or B-frames, where (almost) static regions do not contribute to the video data. It is therefore possible to omit processing of such regions without deteriorating the quality of the final video data 200.

Further, as indicated by arrow C in FIGS. 16 and 17 the control unit 50 may also set encoding modes of the encoding unit 70 based on the received pixel signals from the first subset of pixels, i.e. based on the event data received and analyzed by the control unit 50. For example, the control unit 50 may at the same time as it controls the intensity signal generation or the image processing also set an appropriate encoding mode that ensures that the resulting video data 200 have a sufficiently high frame rate. The control unit 50 may for example set a conventional encoding, if the color frames generated during image processing have full frame rate (i.e. no missing frames of raw intensity signals and no restriction of image processing). Otherwise, the control unit 50 may set appropriately adapted encoding modes as described later, e.g. with respect to FIGS. 22 to 24.

In addition, the control unit 50 may set an encoding mode in which the encoding unit 70 is configured to use smaller encoding blocks for frame data corresponding to parts of the scene with an amount of motion equal to or above a predetermined third motion threshold than for frame data corresponding to parts of the scene with an amount of motion below the third motion threshold. That is, the control unit 50 is configured to refine the block size used for encoding such that areas showing much motion are encoded with smaller blocks than areas with little motion (see FIG. 17, inset C). This reduces the processing burden, and hence the power consumption, of the encoding unit 70, since areas of little motion can be reliably identified and an unnecessary reduction of encoding block sizes can be avoided.

In the above reference has been made on an amount of motion to be detected based on the event data and a comparison of the detected amount of motion with a first to third motion threshold. Here, it should be noted that each pair of the first to third motion thresholds might be identical but may also differ from each other. The amount of motion might e.g. be measured via the number of events counted during a given time interval in a given area. If this number of events exceeds a respective threshold number, the amount of motion exceeds the corresponding motion threshold. Here, the event number count may also be compared to a normalized number that weigh the respective threshold number by the exposure time and the scene contrast. Further, the motion thresholds may be varied according to the captured scene and imaging modes. For example, areas in which a person is present may have a lower motion threshold in order to ensure that full data are generated for such areas.

Further, the manner of counting events in order to determine a motion amount may also be refined. As illustrated in FIG. 18 a), spot metering, i.e. detecting the number of events around a predetermined range point P, like e.g. the center point, can be used to deduce an amount of motion. Just the same, as shown in FIG. 18 b) the number of events might be weighted depending on the distance from a range point such as the center point. This is schematically indicated in FIG. 18 b) by circles at which weights W1 and W2 are applied, respectively.

An alternative to this approach is schematically shown in FIG. 18 c) where not the events at or centered around a specific point are taken into account, but the events across the entire screen, e.g. at lines M of a line matrix, which might be equivalent to the pixel resolution, or by calculating an area density of event across the image. Further alternatively as shown in FIG. 16 d), an object, like a person S, might be identified in a frame image F, and the number of events is counted in the area occupied by the object. Of course, the above event evaluation methods might be combined with each other.

The processing unit 40 may also comprise an event pre-processing unit 90 that pre-processes the event data before they are provided to the encoding unit 70. For example, de-noising can be applied and events generated by flickering can be removed. The event data may also be converted into a representation that is most fitting the further processing. For example, an optical flow can be deduced from the event data, or the events can be ordered in an event (voxel) grid that projects events according to their polarity onto temporal planes such as to generate event frames. Since these event representations are well known to a skilled person it is not necessary to describe them here in further detail. In the following, whenever it is referred to event data processed by the encoding unit 70, this shall also refer to pre-processed event data.

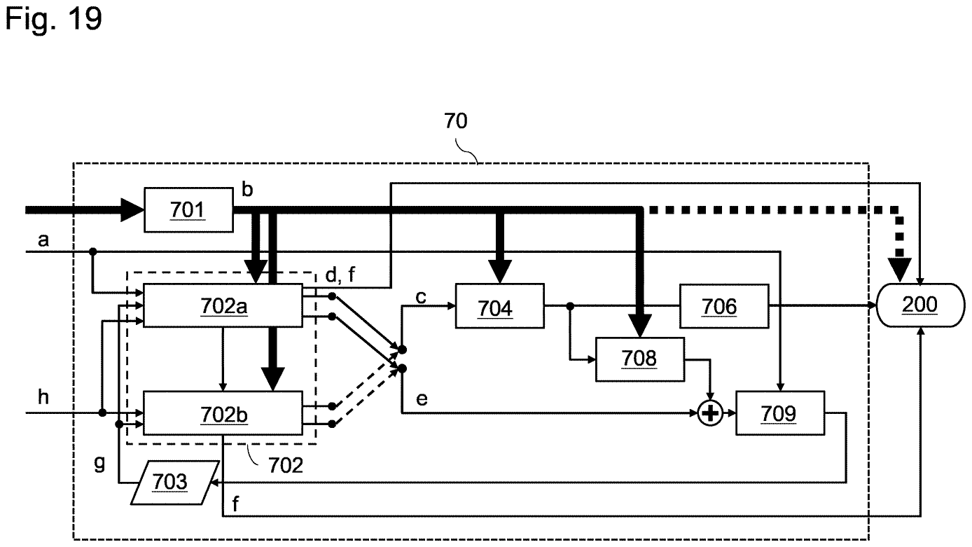

In the following, different encoding modes will be described that can be set by the control unit 50. To this end, reference is first made to FIG. 19 that shows another schematic illustration of the encoding unit 70.

As already explained with respect to FIG. 16, the encoding unit 70 comprises a prediction unit 702, a quantization unit 704, a coder unit 706, and a dequantization unit 708. Here, it should be noted that the subtraction step indicated explicitly in FIG. 16 is considered implemented within the prediction unit 702 in FIG. 19, which outputs the predicted image and the residual. Further, FIG. 19 explicitly shows the addition of the dequantized residual and the predicted image as well as a filter unit 709.

FIG. 19 further illustrates a coding unit control module 701 that receives instructions from the control unit 50 and that instructs the various elements of the encoding unit 70 according to these instruction from the control unit 50, as illustrated by the thick arrows in FIG. 19. Further, the control data may also be provided as metadata to the video data 200 as indicated by the broken, thick arrow.

FIG. 19 also illustrates a buffer unit 703 in which previously encoded images/frames can be stored for the next encoding steps.

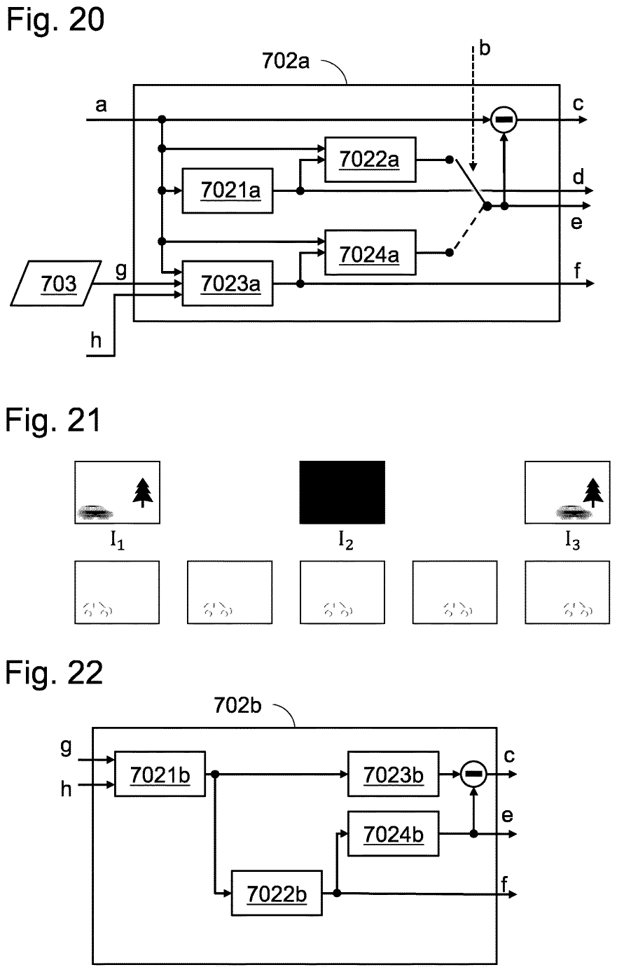

As shown in FIG. 19, the encoding unit 70 may comprise an image-based prediction unit 702a within the prediction unit 702 that performs image prediction as in principle known by a skilled person and as briefly recapitulated below with respect to FIG. 20.

Further, the prediction unit 702 may comprise a hybrid-based prediction unit 702b that carries out image prediction mainly based on the detected event data. Implementations of possible functions of the hybrid-based prediction will be described below with respect to FIGS. 22 to 24.

As schematically illustrated in FIG. 20, the image-based prediction unit 702a comprises an intra-picture estimation unit 7021a that decides how to encode the incoming image, an intra-picture prediction unit 7022a that generates a predicted image based on intra-picture prediction, a motion estimation unit 7023a that measures an optical flow from a previous frame to a current image and a motion compensation unit 7024a that generates a predicted image by applying the optical flow measured by the motion estimation unit 7023a to the previous frame. Based on control data it is decided whether to use the predicted image from intra-picture prediction or from inter-picture prediction, i.e. the predicted image generated by the motion compensation unit 7024a. Thus, the image-based prediction unit 702a operates basically as is well known to a skilled person.

The inputs and outputs of the image-based prediction unit 702a are as follows. a: the color frame from the pixel signal processing unit 60. b: the control signal. c: the residual. d: intra-prediction data. e: the predicted image. f: motion data. g: (the) previously encoded frame(s). Optionally also h: event data may be used by the motion estimation unit 7023a.

Here, the control unit 50 may set an encoding mode in which the encoding unit 70 is configured to estimate an amount of motion between a previous frame and a current frame based on the pixel signals from the first subset of pixels, i.e. based on event data, and to generate the video data based on this estimation.

As is well known to a skilled person video encoding is not necessarily carried out in a temporally ordered manner such that first generated frame data are encoded first. For example, B-frames might be encoded by using data of previously encoded frames that correspond to frames that are temporally located before and after the B-frame. However, while usually such encoding is based on a present color frame, it may be possible to deduce from the event data that frame data for encoding can be produced without having a corresponding color frame at hand.

For example, FIG. 21 shows color frames I₁ and I₃ and a missing color frame I₂ whose contents need to be interpolated. Further FIG. 21 shows event data captured with a higher rate than the rate at which color frames are captured, which event data include information on changes of the observed scene. As all information on movements in the scene is contained in the event data, it is in principle possible to develop a prediction of frame I₂ from the previously encoded frames and the event data.

However, the event data may also indicate that the amount of motion between frames I₁ and I₃ is below a given motion threshold. Then, the encoding unit may generate an interpolation based on the color frames which can then be fed into the image-based prediction unit 702a. Of course, the interpolation may also be carried out by the pixel signal processing unit 60.

As stated above, the encoding unit 70 is configured to generate the video data 200 by processing pixel data of the first subset of pixels, i.e. of the event data, as well as previously encoded frame data. To this end, the hybrid-based prediction unit 702b may be provided. The control unit 50 is then configured to control switching between an encoding mode in which the video data are generated by encoding the frame data output by the pixel signal processing unit 60, i.e. by using the image-based prediction unit 702a as described above, and an encoding mode in which the video data are generated by processing said event data as well as said previously encoded frame data.

This means that based on the retrieved information like e.g. the amount of motion in the scene obtainable from the event data or the contents of the observed scene (presence of humans, amount of fine details to resolve, etc.) the control unit 50 is able to decide whether to encode the frame data in a classical manner or whether to base not only the control of the image capturing, signal processing, and encoding mode on the event data, but also use the event data for the encoding.

To this end, the encoding unit 70 may be set by the control unit 50, preferably via the coding control unit 701, to an encoding mode, in which it processes pixel data of the first subset of pixels, i.e. event data, in order to generate interpolated encoded frame data located temporally between two of the previously encoded frame data used by the encoding unit 70.

Thus, in the situation shown in FIG. 21 in which a frame I₂ is missing the parallelly obtained event data are not only used to determine whether an interpolation of the frame data is possible. Instead, the event data are used to reconstruct the missing frame I₂.

This could be exemplary carried out by a hybrid-based prediction unit 702b that is implemented as schematically shown in FIG. 22. Here, the hybrid-based prediction unit 702b comprises a motion estimation unit 7021b, a motion vector quantization unit 7022b, an interpolating unit 7023b, and a motion compensation unit 7024b.

The motion estimation unit 7021b operates on the event data and on the previously encoded frames I₁ and I₂ that have been generated e.g. by the image-based prediction unit 702a from color frames I₁ and I₂. The motion estimation unit 7021b generates from these data motion vectors v₁₂ and v₂₃ that indicate the motion within the captured scene between the point in time at which frame I₁ was captured to the point in time at which frame I₂ would have been located, and from the point in time of frame I₂ to the point in time at which frame I₃ was captured. The motion vectors are here deduced by analyzing the event data, e.g. by deducing an optical flow therefrom. Motion vector generation may by executed in an analytic manner. Motion vector estimation may also be carried out using artificial intelligence, AI, methods such as a neural network that can be trained, e.g. by large sets of simulated data, to generate motion vectors for any set of previously encoded frame data and corresponding event data.

The motion vector data are on the one hand forwarded to motion vector quantization unit 7022b that quantizes the motion vector data to bring them in the form usually used in encoded video data. These motion data can be forwarded to the video data 200 as in encoding operations that do not use events.

The motion vector data are also provided together with the previously encoded frame data to interpolation unit 7023b that interpolates frame I₂ from this information. For example, interpolation unit 7023b may estimate the temporal development from frame I₁ to frame I₂ based on the motion vector data by a warping function “warp” such that I₂=warp (I₁, v₁₂). Just the same I₂ may be estimated by invers warping from frame I₃: I₂=warp⁻¹(I₃, v₂₃). These two manners of estimation may be reconciled by using a blend rate a:

$${I}_{2} = α \cdot warp ( {I}_{1} , {v}_{12} ) + ( 1 - α ) \cdot {warp}^{- 1} ( {I}_{3} , {v}_{23} ) .$$

Here, each estimation is done pixel wise, i.e. the above formula depends on the pixel position. In the hybrid-based encoding this estimated frame I₂ takes the role of the color frame data of image-based encoding.

While the interpolation unit generates the “true” image, the predicted image is generated in the usual manner by the motion compensation unit 7024b based on the motion vector data and the previous encoded frame data. This predicted image e is output for encoding as in the common case. Further, it is used to generate the residual c by subtracting it from the estimated frame data. Then, also the residual c is output as in the common case. Thus, the hybrid-based prediction unit 702b provides the same output as the image-based prediction unit 702a and allows therefore usage of the same further encoding steps as used in common encoding.

However, the above implementation of the hybrid-based prediction unit 702b allows to lower the frame rate at which color frames are generated, e.g. by one half, without reducing the frame rate of the encoded video data. In this manner high quality video data with a high frame rate can be generated while the power consumption can be reduced.

In the above process, i.e. in generating the interpolated encoded frame data the encoding unit 70 may be configured to additionally use an unprocessed frame of pixel signals of the second subset of pixels, i.e. raw image data, that correspond temporally to the temporal location of the interpolated encoded frame data.

Thus, instead of interpolating the missing frame I₂ solely based on the event data, the encoding unit 70 (or the hybrid-based prediction unit 702b, respectively) is provided with raw image data, i.e. image data that has not been processed by the pixel signal processing unit 60. This raw image data would correspond to the missing frame I₂, if it had been processed, i.e. it corresponds temporally to the temporal location of the frame I₂. Here, as explained above with respect to FIG. 17, processing of the raw image data may not have been omitted totally, but may also have been carried out only partially, e.g. in regions of high motion or in regions of interest. Also such partial data constitute an unprocessed frame of pixel signals of the intensity detecting pixels 51b.

The unprocessed frame data can then be input in addition to the event data into the motion estimation unit 7021b, the motion vector quantization unit 7022b, the interpolation unit 7023b and/or the motion compensation unit 7024b to support the process of frame interpolation, motion vector generation, and/or prediction. Also in this case the different types of data (color frame data, raw data, partial color frame data, event data) can be most efficiently merged by using AI methodology, e.g. by using a neural network.

In this manner, energy consumption by the pixel signal processing unit 60 can be reduced, since not all captured intensity signals need to be processed by the pixel signal processing unit 60. Nevertheless, the quality of the encoded video data is maintained by processing the raw data together with the event data in order to interpolate and predict missing color frames.

According to an alternative or additional implementation the encoding unit 70 is configured to process previously encoded frame data in order to generate extrapolated encoded frame data located temporally after one of the previously encoded frame data used by the encoding unit 70. This might be particularly useful if there are not enough event data to estimate motion vectors. Although not directly based on event data, the according operations might nevertheless be carried out by the hybrid-based prediction unit 702b, since this allows to keep the image-based prediction unit 702a unchanged, i.e. in the form used for common encoding.

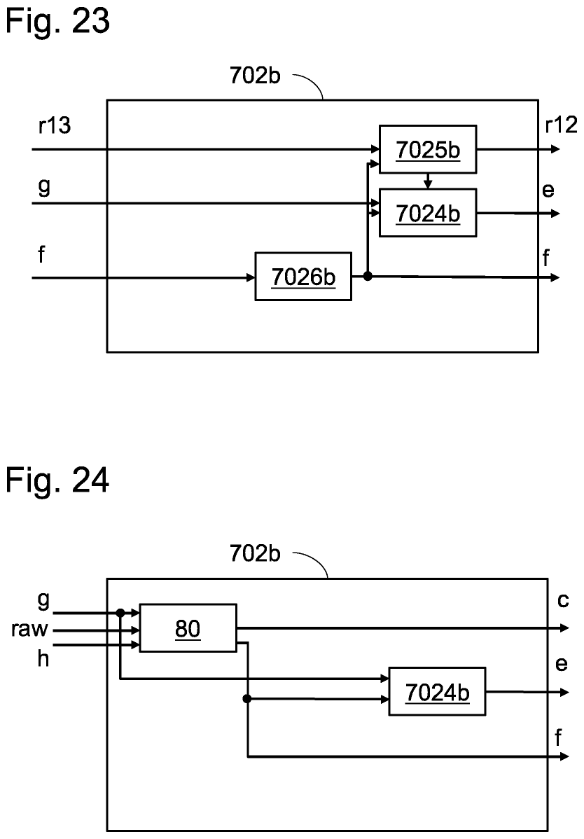

A possible implementation of functions of the hybrid-based prediction unit 702b for this case is shown in FIG. 23. Here, the hybrid-based prediction unit 702b comprises next to the motion compensation unit 7024b also a residual interpolation unit 7025b and a motion interpolation unit 7026b.

The motion interpolation unit 7026b operates on the motion vectors v₁₃ from frame I₁ to I₃. Since no or only a small number of events have been detected, it can be assumed that the motion vectors change linearly with time. The motion interpolation unit 7026b deduces motion vectors v₁₂ from frame I₁ to (would-be) frame I₂ and v₂₃ from frame I₂ to frame I₃ by temporal linear interpolation. This means, if t₁₂ indicates the time between frame I₁ and frame I₂, t₂₃ the time between I₂ and I₃, and t₁₃ the time between I₁ and I₃, then

$${v}_{12} = {v}_{13} \cdot {t}_{12} / {t}_{13} , and {v}_{23} = {v}_{13} \cdot {t}_{23} / {t}_{13}$$

for each pixel.

The residual interpolation unit 7025b operates on the residuals r₁₃ between the estimation of frame I₃ based on frame I₁ and motion vector v₁₃ and the actual frame I₃:

$${r}_{13} = {I}_{3} - warp ( {I}_{1} {r}_{13} ) .$$

The residual interpolation unit 7025b further operates on the motion vectors provided by the motion interpolation unit 7026b. It generates a residual r₁₂ that can be used to extrapolate the frame I₂ from frame I₁ (for all pixels) via:

$${r}_{12} = warp ( {r}_{13} , {v}_{32} ) ; {I}_{2} = warp ( {I}_{1} , {v}_{12} ) + {r}_{12} .$$

The residual interpolation unit 7025b outputs the residual r₁₂ and/or provides the extrapolated frame I₂ to the motion compensation unit 7024b. The motion compensation unit 7024b generates a predicted image based on the information provided thereto. Thus, also in this case data that can be encoded with a standard encoder is output from the hybrid-based prediction unit 702b.

In the above-described implementations of the hybrid-based prediction unit 702b the emphasize was in recreating color frames/motion vectors/residuals that can be used to replace information of the same kind that was missing due to an omission of image capturing or signal processing. This might be helpful in order to keep track of the image interpolation/extrapolation that has been performed.

However, it might also be possible to bypass the generation of such information, if it is not needed, by using AI methods. An example how to generate data for encoding a non-existing frame is shown in FIG. 24. Here, the hybrid-based prediction unit 702b is shown to include a neural network 80 and the motion compensation unit 7024b. The neural network 80 receives previously encoded frame data g, raw image data and event data h. It directly generates a residual c and motion data f of frame I₂ for output. The motion data f and the previously encoded frame data g are used by the motion compensation unit 7024b to generate the predicted image e of frame I₂. Thus, also by training a neural network accordingly, data that can be encoded in the standard manner can be generated although no according frame data have been input into the encoding unit 70.

Here, it is to be understood that as indicated in FIG. 16 the neural network may be trained to directly produce the predicted image, too, i.e. the entire standard prediction can be bypassed.

According to all examples that have been described above the image capturing and/or image processing rate can be reduced in order to reduce energy consumption. The loss in spatially highly resolved information at certain points in time can be compensated by using information that is available with high speed, but with a lower spatial resolution or a smaller production of data, which implies a reduced energy consumption for its generation if compared to the spatially highly resolved information. In this manner, it is possible to generate encoded video data having a high frame rate and a high spatial resolution.

While the above description has been focused on APS pixels and EVS/DVS pixels, it has to be emphasized that any pixels can be used to implement the above examples, as long as the used pixels satisfy the condition that one subset of pixels generate pixel signals faster than pixels of another subset of pixels from which color frames can be generated.

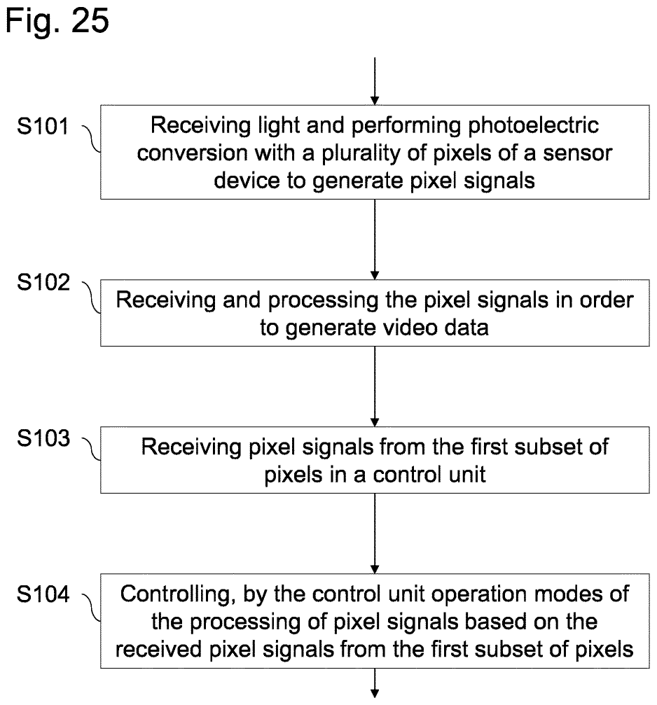

The advantages described above can be achieved by a method for operating a sensor device 10 that is schematically reflected by the process flow of FIG. 25.

At S101 light is received and photoelectric conversion with a plurality of pixels 51 of the sensor device 10 is performed to generate an electrical signal. Here, the plurality of pixels 51 comprise a first subset of pixels and a second subset of pixels, where pixels 51 of the first subset of pixels are capable to generate pixel signals faster and preferably with less spatial resolution than pixels 51 of the second subset of pixels, and wherein color frames can be generated from the pixel signals of the second subset of pixels.

At S102 the pixel signals are received and processed by a processing unit 40 in order to generate video data.

At S103 pixel signals from the first subset of pixels are received in a control unit 50, and at S104 the control unit 50 controls operation modes of the processing unit 40 based on the received pixel signals from the first subset of pixels.

In this manner it is possible to reduce energy consumption in the creation of video data having a high frame rate and a high spatial resolution.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

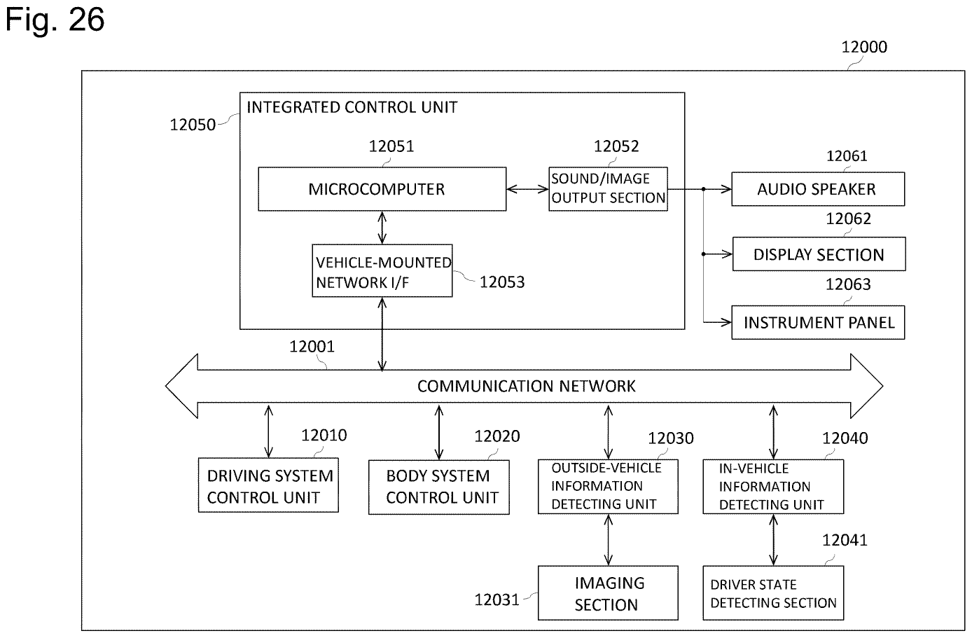

FIG. 26 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 26, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 26, an audio speaker 12061, a display section 12062, and an instrument panel 12063 are illustrated as the output device. The display section 12062 may, for example, include at least one of an on-board display and a head-up display.

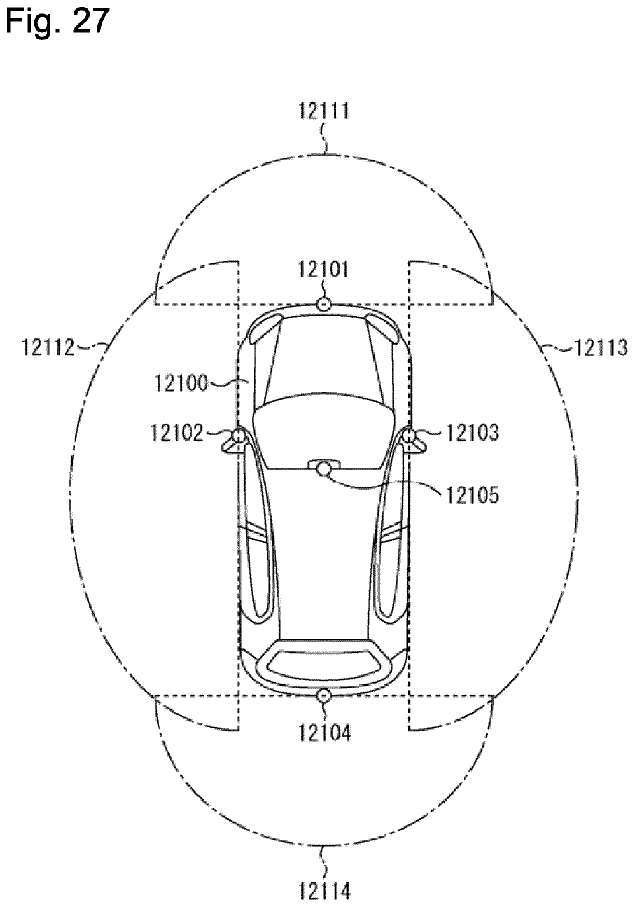

FIG. 27 is a diagram depicting an example of the installation position of the imaging section 12031.

In FIG. 27, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 27 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

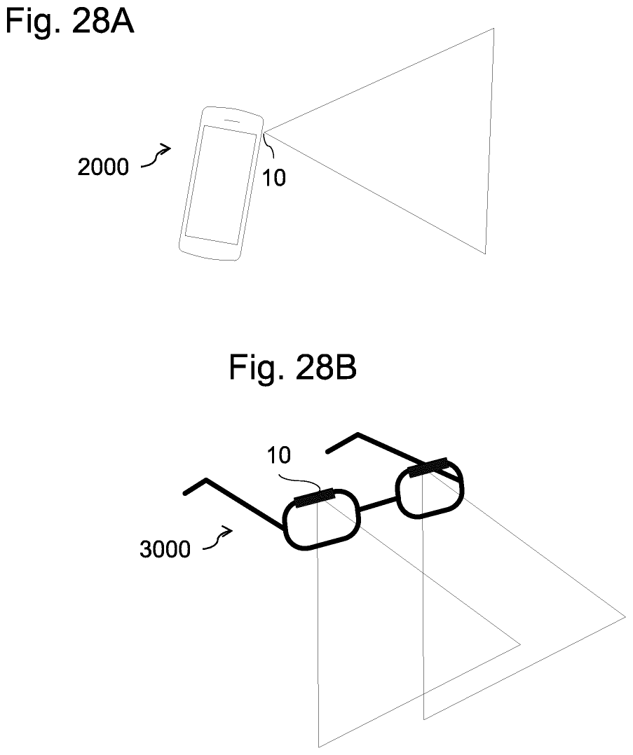

Further possible implementations of the sensor device 10 are mobile devices 2000 such as cell phones, tablets, smart watches and the like as shown in FIG. 28A or head-mounted displays as shown in FIG. 28B. Further, the sensor device 10 is useable in augmented and/or virtual reality applications/cameras or in surveillance systems like 360° cameras.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.
1. A sensor device configured to capture a video of a scene, the sensor device comprising:
   a plurality of pixels each configured to receive light and perform photoelectric conversion to generate a pixel signal, the plurality of pixels comprising a first subset of pixels and a second subset of pixels, where pixels of the first subset of pixels are capable to generate pixel signals faster and preferably with less spatial resolution than pixels of the second subset of pixels, and wherein color frames can be generated from the pixel signals of the second subset of pixels;
   a processing unit that is configured to receive and process the pixel signals in order to generate video data; and
   a control unit that is configured to receive pixel signals from the first subset of pixels and to control operation modes of the processing unit based on the received pixel signals from the first subset of pixels.
2. The sensor device according to 1, further comprising
   event detection circuitry that is configured to generate as pixel signals event data by detecting as events intensity changes above a predetermined threshold of the light received by each of event detecting pixels that form the first subset of the pixels; and
   intensity signal generating circuitry that is configured to generate as pixel signals intensity signals indicating intensity values of the light received by each of intensity detecting pixels that form the second subset of the pixels.
3. The sensor device according to any one of 1 and 2, wherein
   the control unit is configured to control readout of the pixel signals from the second subset of pixels based on the received pixel signals from the first subset of pixels.
4. The sensor device according to 3, wherein
   the control unit is configured to determine an amount of motion in the captured scene from the pixel signals of the first subset of pixels;
   the control unit is configured to lower a readout rate of pixel signals of the second subset of pixels, if the determined amount of motion is below a predetermined first motion threshold; and
   the control unit is configured to set an operation mode of the processing unit in which the processing unit is configured to interpolate between readout pixel signals of the second subset of pixels in order to generate the video data with a predetermined frame rate, preferably with a frame rate of 60 or more frames per second.
5. The sensor device according to any one of 1 to 4, wherein
   the processing unit comprises a pixel signal processing unit that is configured to receive the pixel signals of the second subset of pixels and to process the received pixel signals in order to generate color frames therefrom.
6 The sensor device according to 5, wherein
   the control unit is configured to determine an amount of motion in parts of the captured scene from the pixel signals of the first subset of pixels;
   the control unit is configured to set an operation mode of the processing unit in which the pixel signal processing unit is configured to generate frames from the pixel signals of the second subset of pixels in which pixel signals corresponding to parts of the scene with an amount of motion below a predetermined second motion threshold are processed differently than pixel signals corresponding to parts of the scene with an amount of motion equal to or above the second motion threshold.
7. The sensor device according to 6, wherein
   the control unit is configured to control the pixel signal processing unit to process the pixel signals corresponding to parts of the scene with an amount of motion equal to or above the second motion threshold such as to generate color frame data therefrom, and to not process the pixel signals corresponding to parts of the scene with an amount of motion below the second motion threshold or to process these pixel signals by generating grayscale frame data therefrom.
8. The sensor device according to any one of 5 to 7, wherein
   the processing unit comprises an encoding unit that is configured to generate the video data by encoding the frame data output by the pixel signal processing unit; and
   the control unit is configured to set encoding modes of the encoding unit based on the received pixel signals from the first subset of pixels.
9. The sensor device according to 8, wherein
   the control unit is configured to set an encoding mode in which the encoding unit is configured to use smaller encoding blocks for frame data corresponding to parts of the scene with an amount of motion equal to or above a predetermined third motion threshold than for frame data corresponding to parts of the scene with an amount of motion below the third motion threshold.
10. The sensor device according to 8 or 9, wherein
   the control unit is configured to set an encoding mode in which the encoding unit is configured to estimate an amount of motion between a previous frame and a current frame based on the pixel signals from the first subset of pixels and to generate the video data based on this estimation.
11. The sensor device according to any one of 8 to 10, wherein
   the encoding unit is configured to generate the video data by processing pixel data of the first subset of pixels as well as previously encoded frame data; and
   the control unit is configured to control switching between an encoding mode in which the video data are generated by encoding the frame data output by the pixel signal processing unit and an encoding mode in which the video data are generated by processing said pixel data of the first subset of pixels as well as said previously encoded frame data.
12. The sensor device according to 11, wherein
   the encoding unit is configured to process pixel data of the first subset of pixels in order to generate interpolated encoded frame data located temporally between two of the previously encoded frame data used by the encoding unit.
13. The sensor device according to 12, wherein
   in generating the interpolated encoded frame data the encoding unit is configured to additionally use an unprocessed frame of pixel signals of the second subset of pixels that corresponds temporally to the temporal location of the interpolated encoded frame data.
14. The sensor device according to any one of 11 to 13, wherein
   the encoding unit is configured to process previously encoded frame data in order to generate extrapolated encoded frame data located temporally after one of the previously encoded frame data used by the encoding unit.
15. A method for operating a sensor device that is configured to capture a video of a scene, the method comprising:
   receiving light and performing photoelectric conversion with each of a plurality of pixels to generate a pixel signal with each of the pixels, the plurality of pixels comprising a first subset of pixels and a second subset of pixels, where pixels of the first subset of pixels are capable to generate pixel signals faster and with less spatial resolution than pixels of the second subset of pixels, and wherein color frames can be generated from the pixel signals of the second subset of pixels;
   receiving and processing the pixel signals by a processing unit in order to generate video data; and
   receiving pixel signals from the first subset of pixels in a control unit and controlling, by the control unit, operation modes of the processing unit based on the received pixel signals from the first subset of pixels.

1. A sensor device configured to capture a video of a scene, the sensor device comprising:
a plurality of pixels each configured to receive light and perform photoelectric conversion to generate a pixel signal, the plurality of pixels comprising a first subset of pixels and a second subset of pixels, where pixels of the first subset of pixels are capable to generate pixel signals faster and preferably with less spatial resolution than pixels of the second subset of pixels, and wherein color frames can be generated from the pixel signals of the second subset of pixels;
a processing unit that is configured to receive and process the pixel signals in order to generate video data; and
a control unit that is configured to receive pixel signals from the first subset of pixels and to control operation modes of the processing unit based on the received pixel signals from the first subset of pixels.

2. The sensor device according to claim 1, further comprising
event detection circuitry that is configured to generate as pixel signals event data by detecting as events intensity changes above a predetermined threshold of the light received by each of event detecting pixels that form the first subset of the pixels; and
intensity signal generating circuitry that is configured to generate as pixel signals intensity signals indicating intensity values of the light received by each of intensity detecting pixels that form the second subset of the pixels.

3. The sensor device according to claim 1, wherein
the control unit is configured to control readout of the pixel signals from the second subset of pixels based on the received pixel signals from the first subset of pixels.

4. The sensor device according to claim 3, wherein
the control unit is configured to determine an amount of motion in the captured scene from the pixel signals of the first subset of pixels;
the control unit is configured to lower a readout rate of pixel signals of the second subset of pixels, if the determined amount of motion is below a predetermined first motion threshold; and
the control unit is configured to set an operation mode of the processing unit in which the processing unit is configured to interpolate between readout pixel signals of the second subset of pixels in order to generate the video data with a predetermined frame rate, preferably with a frame rate of 60 or more frames per second.

5. The sensor device according to claim 1, wherein
the processing unit comprises a pixel signal processing unit that is configured to receive the pixel signals of the second subset of pixels and to process the received pixel signals in order to generate color frames therefrom.

6. The sensor device according to claim 5, wherein
the control unit is configured to determine an amount of motion in parts of the captured scene from the pixel signals of the first subset of pixels;
the control unit is configured to set an operation mode of the processing unit in which the pixel signal processing unit is configured to generate frames from the pixel signals of the second subset of pixels in which pixel signals corresponding to parts of the scene with an amount of motion below a predetermined second motion threshold are processed differently than pixel signals corresponding to parts of the scene with an amount of motion equal to or above the second motion threshold.

7. The sensor device according to claim 6, wherein
the control unit is configured to control the pixel signal processing unit to process the pixel signals corresponding to parts of the scene with an amount of motion equal to or above the second motion threshold such as to generate color frame data therefrom, and to not process the pixel signals corresponding to parts of the scene with an amount of motion below the second motion threshold or to process these pixel signals by generating grayscale frame data therefrom.

8. The sensor device according to claim 5, wherein
the processing unit comprises an encoding unit that is configured to generate the video data by encoding the color frames output by the pixel signal processing unit; and
the control unit is configured to set encoding modes of the encoding unit based on the received pixel signals from the first subset of pixels.

9. The sensor device according to claim 8, wherein
the control unit is configured to set an encoding mode in which the encoding unit is configured to use smaller encoding blocks for frame data corresponding to parts of the scene with an amount of motion equal to or above a predetermined third motion threshold than for frame data corresponding to parts of the scene with an amount of motion below the third motion threshold.

10. The sensor device according to claim 8, wherein
the control unit is configured to set an encoding mode in which the encoding unit is configured to estimate an amount of motion between a previous frame and a current frame based on the pixel signals from the first subset of pixels and to generate the video data based on this estimation.

11. The sensor device according to claim 8, wherein
the encoding unit is configured to generate the video data by processing pixel data of the first subset of pixels as well as previously encoded frame data; and
the control unit is configured to control switching between an encoding mode in which the video data are generated by encoding the frame data output by the pixel signal processing unit and an encoding mode in which the video data are generated by processing said pixel data of the first subset of pixels as well as said previously encoded frame data.

12. The sensor device according to claim 11, wherein
the encoding unit is configured to process pixel data of the first subset of pixels in order to generate interpolated encoded frame data located temporally between two of the previously encoded frame data used by the encoding unit.

13. The sensor device according to claim 12, wherein
in generating the interpolated encoded frame data the encoding unit is configured to additionally use an unprocessed frame of pixel signals of the second subset of pixels that corresponds temporally to the temporal location of the interpolated encoded frame data.

14. The sensor device according to claim 11, wherein
the encoding unit is configured to process previously encoded frame data in order to generate extrapolated encoded frame data located temporally after one of the previously encoded frame data used by the encoding unit.

15. A method for operating a sensor device that is configured to capture a video of a scene, the method comprising:
receiving light and performing photoelectric conversion with each of a plurality of pixels to generate a pixel signal with each of the pixels, the plurality of pixels comprising a first subset of pixels and a second subset of pixels, where pixels of the first subset of pixels are capable to generate pixel signals faster and preferably with less spatial resolution than pixels of the second subset of pixels, and wherein color frames can be generated from the pixel signals of the second subset of pixels;
receiving and processing the pixel signals by a processing unit in order to generate video data; and
receiving pixel signals from the first subset of pixels in a control unit and controlling, by the control unit, operation modes of the processing unit based on the received pixel signals from the first subset of pixels.
